(19) United States
(12) Patent Application Publication
(10) Pub. No.: US 2003/0128030 A1
(43) Pub. Date: Jul. 10, 2003

(54) Method and device for detection and evaluation of surface damage to laid tracks and points components

(76) Inventors: Hartmut Hintze, Milow (DE); Martin Junger, Grafenberg (DE); Volker Kiesow, Magdeburg (DE); Ronald Krull, Stendal (DE); Rainer Pohl, Berlin (DE); Juergen Rohmann, Battenberg (DE); Sven Ruehe, Lostau (DE); Hans-Martin Thomas, Berlin (DE)

Correspondence Address: Thomas M Galgano, Galgano & Burke, Suite 135, 300 Rabro Drive, Hauppauge, NY, 11788, US

(21) Appl. No.: 10/276,972

(22) PCT Filed: May 21, 2001
(86) PCT No.: PCT/DE01/01907

(51) Int. Cl. G01N 27/82; B61K 9/10

(52) U.S. Cl. 324/217; 324/238

(57) ABSTRACT

The rails (10) or switch components are scanned with one or more eddy-current inspection probe(s) (20) and the measured signal of the probe(s) is plotted as a function of position. The probe(s) (20) is/are seated on a measuring head, which is guided along the rail (10). A GPS unit (26) equipped with a gyro module (32) is used as the position-signal generator.

In the prior art, laid railroad rails and switches are visually inspected-for surface defects by a lineman. Rail-inspection trains equipped with ultrasonic inspection systems are also used. This ultrasonic inspection is capable of detecting discontinuities in the interior of the rails. On the other hand, discontinuities and inhomogeneities in the near-surface region, such as head checks and squats, are not measured with this ultrasonic inspection.

The object of the invention is to provide a method and a device with which defects in the near-surface region of laid rails and switch components can be detected precisely, reliably and with accurate identification of position, and can also be analyzed quantitatively.

This object is achieved by a method in which the rail or the switch component is scanned with one or more eddy-current inspection probes and the measured signal of the probe(s) is plotted as a function of position.

In a preferred alternative embodiment of the method, two rails laid next to one another at a fixed spacing are scanned with at least one probe each, and the measured signals of the probes are recorded in parallel.

The device that achieves the object is provided with an eddy-current inspection probe, a position-signal generator and a recording unit, to which the measured signal of the probe(s) and the position signal of the position-signal generator are delivered for simultaneous recording.

In a preferred embodiment of the device, the probe(s) is/are seated on a measuring head, which is guided along the rail. The measuring head can slide over the rail in the manner of a sled, and/or can be guided with rollers along the rail or the switch component.

The position-signal generator is preferably a GPS (Global Positioning System) unit. A GPS unit commercially available for civil applications is capable of determining position with an accuracy of about 3 m. Thus, once surface defects have been detected, they can be located once again without problems. This makes it possible to follow the evolution of the defects, to plan optimally for repair of the defects and to monitor the success of the repair. Modern quality management can be applied to the railroad system, and valuable information for future planning of track installations can be obtained.

In a preferred embodiment, the GPS unit is equipped with a gyro module. In this way there is performed an acceleration measurement, which in turn permits extrapolation of the position signal when the GPS signal is interrupted, for example during passage through a tunnel.

Another version of the inventive device is designed to be operated as a hand-held inspection system by a lineman, who preferably scans only an individual rail therewith. This relatively expensive form of the inspection is necessary for track sections, such as switch areas, that are currently not accessible to automated inspection.

Another version of the inventive device is designed to be transported by a rail-mounted trolley, which can be operated both with human muscle power and by a motor. Preferably both rails on which the trolley is running are sampled in an automated inspection.

The same is true for versions of the inventive device that are designed to be transported by a rail-inspection train or rail-grinding train. With the rail-inspection train, inspection data for the entire track network of the railroad are obtained over the course of approximately one year of operation. The device transported by a rail-grinding train helps to optimize grinding operations by continuous operation, so that satisfactory surface quality of the rail is achieved with the least possible removal of material.

In the versions transported by a trolley or train, it is recommended that the measuring head containing the probe(s) be attached floatingly to the rail vehicle and be allowed to slide along or roll on the rail in a manner guided by the rail itself.

In a preferred embodiment, a distance pulse signal from a distance sensor whose reference point is the rail or the switch component is delivered to the recording unit of an inventive device being transported by a rail vehicle.

The invention will be explained in more detail hereinafter on the basis of a practical example illustrated in the drawing, wherein:

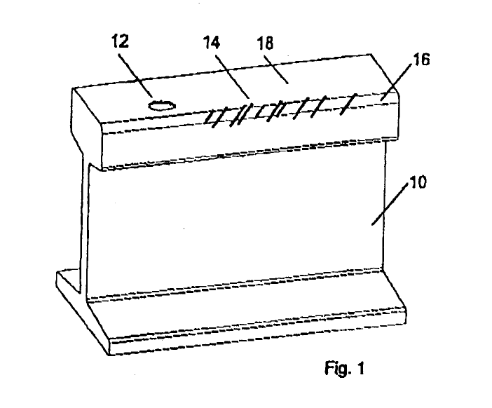

FIG. 1 shows a perspective view of a rail with surface defects that typically must be detected;

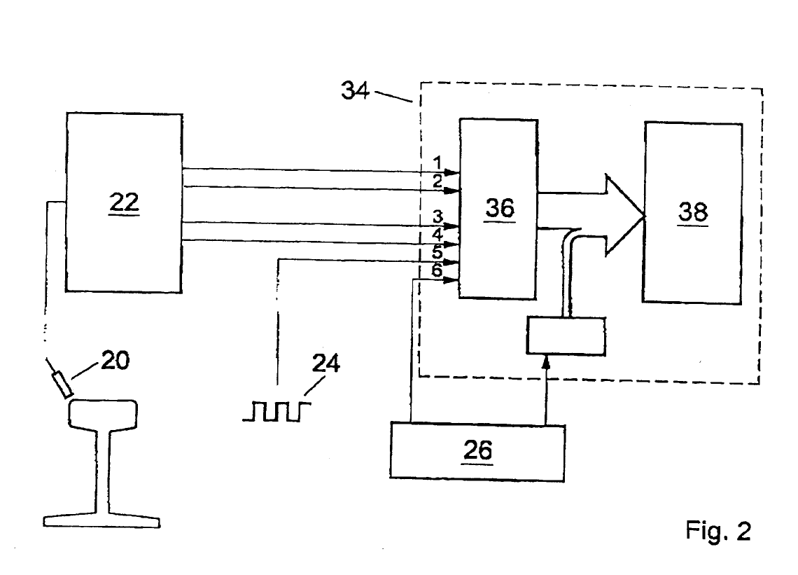

FIG. 2 shows the block diagram of an eddy-current inspection device for inspection of rails and switch components; and

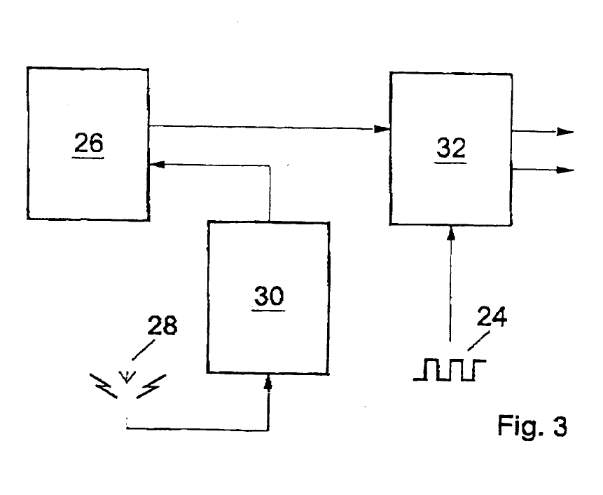

FIG. 3 shows the block diagram of a GPS unit belonging to the eddy-current inspection device.

FIG. 1 shows a railroad rail of steel with typical surface defects in the form of squats 12 and head checks 14.

Squats 12 are shallow discontinuities located under the upper surface 18 of the rail and oriented mainly parallel to the surface.

Head checks 14 are cracks with inclined orientation in the vicinity of the gauge corner 16, and occur mainly along the outer rail of curves.

Detection and assessment of head checks 14 are difficult because they are inclined relative to the travel direction and penetrate into rail 10 at a shallow angle. The position of head checks 14 must be measured with an accuracy of a few meters, whereas their spacing and depth require measurement accuracy on the millimeter scale.

FIG. 2 shows the block diagram of an eddy-current inspection device used for this purpose. It includes an eddy-current inspection probe 20, which is disposed facing gauge corner 16 and which samples rail 10 by the magnetic induction technique, in order to detect and assess head checks 14.

Probe 20 is connected to a multi-channel eddy-current inspection instrument 22. Each further channel can be assigned a further probe, which is not illustrated in more detail but which, for example, samples upper surface 18 of rail 10 for squats 12.

The eddy-current inspection device can be mounted on a rail-inspection train, which is running on a pair of rails to be examined. In this case, a distance pulse signal 24 is obtained from a distance sensor.

A GPS (Global Positioning System) unit 26 delivers position coordinates with an uncertainty that at present is about 3 m.

As shown in FIG. 3, GPS unit 26 is equipped with an antenna 28, a decoder 30 and a gyro module 32, to which distance pulse signal 24 is applied. Gyro module 32 is used for extrapolation of the position determination when GPS reception is interrupted, such as during passage through a tunnel.

The output signal of eddy-current inspection instrument 22, together with distance pulse signal 24 and the position signal, is applied to a PC 34. The signals are subjected to analog-to-digital conversion 36 and on-line data processing, and are stored on a hard disk 38.

Table 1 contains particulars about the data flow at different running speeds. For evaluation of six 12-bit channels, the present embodiment corresponds to a data flow of 1 MB/s and a memory requirement of 3.6 GB/h.

TABLE 1

| | Minimum | Normal | Maximum | |
|---|---|---|---|---|
| Running speed | 30 | 70 | 100 | km/h |
| Inspection speed | 8 | 19.5 | 28 | m/s |
| Sample rate | 13 | 33 | 50 | kS/s |
| Measured-point spacing at 50 | 0.16 | 0.39 | 0.56 | mm |
| kS/s | | | | |

List of reference symbols

| | |
|---|---|
| 10 | Rail |
| 12 | Squat |
| 14 | Head check |
| 16 | Gauge corner |
| 18 | Upper surface |
| 20 | Probe |
| 22 | Eddy-current inspection instrument |
| 24 | Distance pulse signal |
| 26 | GPS unit |
| 28 | Antenna |
| 30 | Decoder |
| 32 | Gyro module |
| 34 | PC |
| 36 | Analog-to-digital converter |
| 38 | Hard disk |

1. A method and device for detection and assessment of surface defects (12, 14) on laid rails (10) and switch components, wherein the rails (10) or switch components are scanned with at least one eddy-current inspection probe (20), and the measured signal of the probe(s) (20) is plotted as a function of position.

2. A method according to claim 1, characterized in that two rails (10) laid next to one another at a fixed spacing are scanned with at least one probe (20) each, and the measured signals of the probes (20) are recorded in parallel.

3. A device for performing the method according to claim 1 or 2, provided with at least one eddy-current inspection probe (20), a position-signal generator and a recording unit, to which the measured signal of the probe(s) (20) and the position signal of the position-signal generator can be delivered for simultaneous recording.

4. A device according to claim 3, characterized in that the probe(s) (20) is/are seated on a measuring head, which is guided along the rail (10) or switch components.

5. A device according to claim 4, characterized in that the measuring head slides over the rail (10) or switch components.

6. A device according to claim 4 or 5, characterized in that the measuring head is guided with rollers along the rail (10) or switch component.

7. A device according to one of claims 3 to 6, characterized in that the position-signal generator is a GPS (Global Positioning System) unit (26).

8. A device according to claim 7, characterized in that the GPS unit (26) is equipped with a gyro module (32).

9. A device according to one of claims 3 to 8, designed to be operated as a hand-held inspection system by a lineman.

10. A device according to one of claims 3 to 8, designed to be transported by a rail-mounted trolley.

11. A device according to one of claims 3 to 8, designed to be transported by a rail-inspection train.

12. A device according to one of claims 3 to 8, designed to be transported by a rail-grinding train.

13. A device according to one of claims 4 to 8 and 10 to 13, characterized in that the measuring head containing the probe(s) (20) is attached floatingly to the rail vehicle and is guided along the rail (10) or the switch component itself.

14. A device according to one of claims 10 to 13, characterized in that a distance pulse signal from a distance sensor whose reference point is the rail (10) or the switch component can be delivered to the recording unit.
